(19) United States
(12) Patent Application Publication
(10) Pub. No.: US 2024/0304364 A1
(43) Pub. Date: Sep. 12, 2024

(54) VARISTOR MODULE AND METHOD OF MANUFACTURING A VARISTOR MODULE

(71) Applicant: TDK Electronics AG, Munchen (DE)

(72) Inventors: Yongde HUANG, Zhuhai (CN); Wen YANG, Zhuhai (CN); Xiaojia TIAN, Zhuhai (CN); Zhouquan HE, Zhuhai (CN); Dyego KRAUSE, Zhuhai (CN); Hao LIU, Zhuhai (CN)

(21) Appl. No.: 18/595,833

(22) Filed: Mar. 5, 2024

(30) Foreign Application Priority Data
Mar. 7, 2023 (DE) 102023105611.5

(51) Int. Cl. H01C 7/12; H01C 17/28; H01R 4/62; H01R 43/02

(52) U.S. Cl. CPC H01C 7/12; H01C 17/28; H01R 4/625; H01R 43/02

(57) ABSTRACT

A varistor module and a method of manufacturing the varistor module is provided. The varistor module includes a varistor, a contact element which is fixed to the varistor, and a terminal. The terminal comprises a metal contact. The contact element is fixed to the metal contact, and the metal contact comprises a lower face which faces away from the varistor and which is configured for surface mounting.

### CROSS-REFERENCE TO RELATED APPLICATIONS

This application claims the benefit of and priority to Germany Patent Application No. 102023105611.5, filed Mar. 7, 2023, which is incorporated herein by reference in its entirety.

### FIELD

The present invention concerns a varistor module and a method of manufacturing the varistor module.

### BACKGROUND

In applications, in which a high surge capability is crucial, in particular for ESD protection, it is common to use monolithic disc varistors which can be soldered by two lead terminals. However, problems can occur when this type of varistor module is used in an SMD (surface mounted device) application. The soldering connection of the lead terminal to the varistor disc is susceptible to damage by high temperatures occurring during the SMD process. If the lead contacts are soldered to the varistor disc and then the final device is used in an SMD process, the heat applied during the SMD process may unfasten the solder contact between the lead contact and the varistor, resulting in a malfunction of the device.

### SUMMARY

It is the object of the present invention to provide an improved varistor module and a method for its manufacturing.

A varistor module is proposed which comprises a varistor, a contact element which is fixed to the varistor and a terminal comprising a metal contact, wherein to the contact element is fixed the metal contact and wherein the metal contact comprises a lower face which faces away from the varistor and which is configured for surface mounting.

The contact element itself is not intended to be used as a contact surface for surface mounting. Instead, the contact element is fixed to the metal contact of the terminal which is surface mountable, i.e. which is configured to be uses as a contact surface for surface mounting. Thereby, it can be ensured that high temperatures occurring during the SMD process are not applied directly to the contact element, but only indirectly in a somewhat reduced degree to the contact element via the metal contact. This design protects the fixation of the contact element to the varistor and prevents the connection of the contact element to the varistor from melting.

The addition of the terminal may make a varistor with contact elements comprising lead compatible with the surface mounting technology. Even existing varistors with contact elements can be combined with the terminal, thereby making varistors surface mountable which could previously not be surface mounted.

The varistor may be a monolithic disc with electrodes on its upper surface and on its lower surface. The contact element may be a strap-shaped element which is fixed to the electrodes of the varistor, for example by soldering or welding. The contact element may be used to apply an electrical signal to the varistor. The electrical signal is applied from the outside via the metal contact and the contact element to the varistor. In particular, high voltages and/or high currents may be applied to the varistor via the contact element.

The contact element may comprise lead. The contact element may consist of lead. The contact element may be covered by the coating comprising copper or consisting of copper. The contact element may be covered by the coating comprising tin or consisting of tin. The use of lead in an ESD applications is advantageous as lead can withstand high surge loads. The contact element may comprise Cu-coated steel, Sn-coated steel, Cu-plated steel or Sn-plated steel.

The contact element may be fixed to the varistor by soldering or by welding.

Preferably, the contact element is welded to the metal contact. Alternatively, the contact element is soldered to the metal contact. In particular, a high temperature solder having a melting temperature of more than 250° C. may be used for soldering the contact element to the metal contact. Both of welding and soldering provide the advantage that a high temperature is applied only locally at the position at which the contact element is fixed to the metal contact. This local occurrence of a high temperature may not unfasten a connection of the contact element and the varistor.

The terminal may comprise a plastic base wherein the metal contact is integrated in the plastic base. The plastic base may comprise a plastic material which can withstand high temperatures, in particular the high temperatures occurring during reflow soldering. For example, the plastic base may comprise liquid crystal polymer (LCP) or may consist of LCP. Alternatively, the plastic base may comprise another plastic material.

The metal contacts integrated in the plastic base can be arranged in the plastic base such that a lower face of the metal contact is arranged at a lower surface of the terminal facing away from the varistor and such that an upper face of the metal contact is arranged at an upper face of the terminal facing to the varistor.

The metal contact may comprise an upper face and a welding area. The upper face may be parallel to the lower face and may face towards the varistor when the varistor is fixed to the terminal. The welding area may be perpendicular to the upper face and may protrude towards the varistor. The contact element may be welded to the welding area.

The varistor and the contact element may be covered by a coating. For example, the varistor and the contact element may be covered by a coating comprising a plastic material or a glass material. The coating may provide additional protection of the connection between the varistor and the contact elements against heat.

The varistor module may further comprise a housing, wherein the varistor and the contact element are arranged in the housing and wherein the terminal and the housing enclose a cavity in which the varistor and the contact element are arranged. The housing may protect the varistor against environmental impact such as moisture or dust. Moreover, air may be arranged between an inner surface of the housing and the varistor. The air layer may provide thermal protection which prevents heat transfer during an SMD process to the connection between the contact element and the varistor, thereby also improving the heat resistance of the varistor module.

The varistor module may comprise more than one varistor. For example at least a second varistor may be provided which comprises a second contact element fixed to the second varistor, wherein the terminal comprises a second metal contact fixed, e.g. by welding or soldering, to the second contact element, wherein the second metal contact comprises a lower face which faces away from the second varistor and which is configured for surface mounting. Accordingly, two or more varistors may be fixed to one terminal by welding or soldering the respective contact elements to the respective metal contacts of the terminal. Thereby, the terminal may protect a connection between each varistor and each contact element from melting during SMD processes.

Another aspect concerns a method of manufacturing a varistor module. The varistor module manufactured by this method may be the above-described varistor module. The method comprises the following steps:
providing a varistor with a contact element fixed to the varistor,
providing a terminal comprising a metal contact, which comprises a lower face configured for surface mounting, and
fixing, e.g. welding, the contact element to the metal contact such that the lower face of the metal contact faces away from the varistor.

The method may further comprise the step of placing a housing over the varistor and over the contact element such that the housing and the terminal enclose a cavity.

The contact element may be fixed to the varistor by soldering or by welding.

The method may also comprise the steps of:
providing a second varistor with a second contact element fixed to the second varistor, wherein the terminal comprises a second metal contact, which comprises a lower face configured for surface mounting, and
fixing, e.g. welding, the second contact element to the second metal contact such that the lower face of the second metal contact faces away from the second varistor.

### BRIEF DESCRIPTION OF THE DRAWINGS

The patent or application file contains at least one drawing executed in color. Copies of this patent or patent application publication with color drawing (s) will be provided by the Office upon request and payment of the necessary fee.

In the following, preferred embodiments of the invention are described in detail with reference to the figures.

Each of FIGS. 1 and 2 shows a varistor module in a perspective view.

FIG. 3 shows a terminal.

FIG. 4 shows a metal contact.

FIG. 5 shows a perspective view of a varistor module comprising a housing.

FIG. 6 shows a varistor module according to a second embodiment wherein multiple varistors are arranged on a single terminal.

FIG. 7 shows the welding method of the welding process.

### DETAILED DESCRIPTION

Each of FIGS. 1 and 2 shows a varistor module in a perspective view.

The varistor module comprises a varistor 1, two contact elements 2, 3 and a terminal 4.

The varistor 1 has a first outer electrode at its upper surface and a second outer electrode at its lower surface. The varistor 1 is a monolithic varistor disc. The varistor 1 is constructed as a monolithic varistor disc. A monolithic varistor disc has a very high surge capability. The varistor 1 is intended to be used for surge protection. For example, the varistor module may be part of an ESD protection device (ESD=electrostatic discharge).

The contact elements 2, 3 are strap or lead terminals. One of the contact elements 2 is connected to the first outer electrode of the varistor 1 and the other contact element 3 is connected to the second outer electrode of the varistor 1.

The contact elements 2, 3 are fixed to the varistor 1 by soldering. In particular, a first end of each strap shaped contact element 2, 3 is fixed to the varistor 1, e.g. by soldering. As an alternative to a soldering connection, the contact elements 2, 3 may be welded to the varistor 1. Compared to mechanical connections, like a clamping connection, a soldering connection and a welding connection can withstand higher surge loads.

The contact elements 2, 3 consist of lead which is Tin plated copper lead or Tin plated high conductive metal lead.

The varistor 1 and the contact elements 2, 3 are covered by a coating 5, which may be applied by over-molding. The coating 5 comprises a material which has a high humidity resistance, for example an epoxy resin or silicone. The coating 5 provides protection against external influences like dust, moisture, etc. Moreover, the coating also lowers a heat transfer from the outside to the varistor 1.

The varistor module is intended for a surface mounting.

As will be described below, the varistor is constructed such that heat which is applied during the SMD process, in particular during reflow soldering, does not unfasten the contact between the contact elements 2, 3 and the varistor 1. Unfastening the contact between the contact elements 2, 3 and the varistor 1 would otherwise result in a malfunction of the varistor module. In particular, the addition of the terminal 4 ensures that the connection of the contact elements 2, 3 and the varistor 1 is not excessively heated during the SMD process such that an unfastening of the contact between the contact elements 2, 3 and the varistor 1 is prevented.

The contact elements 2, 3 are not directly surface mounted on an application, e.g. on a printed circuit board. Instead, the varistor module comprises the terminal 4 wherein the contact elements 2, 3 are fixed to the terminal. In particular, an end of the strip-shaped contact elements 2, 3 which is opposite of the end fixed to the varistor 1 is fixed to the terminal 4. The contact elements 2, 3 are fixed to the terminal 4 either by welding or by soldering with a high temperature solder which has a melting point of more than 250° C.

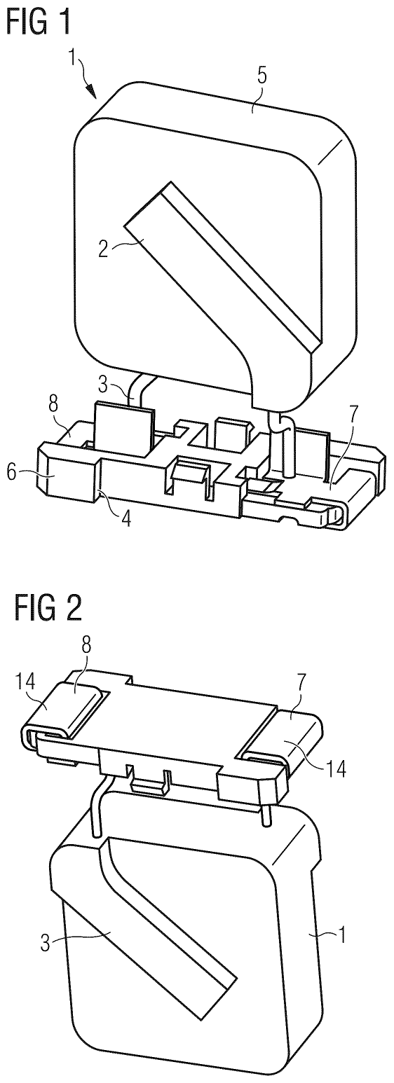

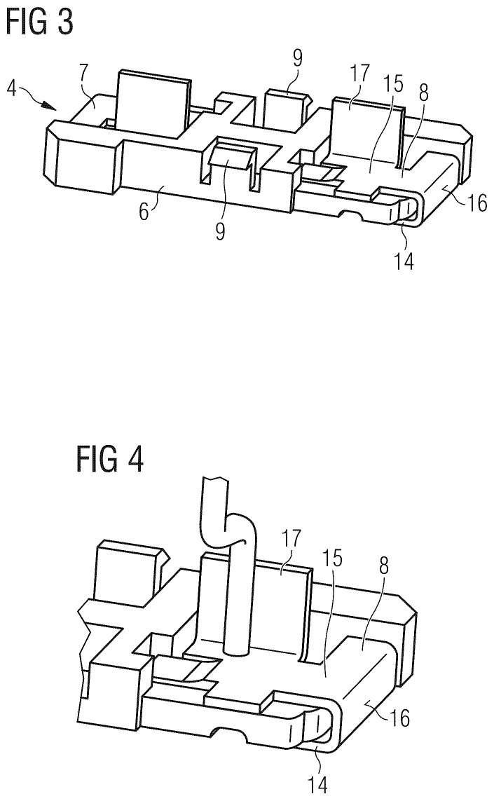

FIG. 3 shows a more detailed view of the terminal 4. The terminal 4 comprises a plastic base 6 and two metal contacts 7, 8. The terminal 4 is arranged at a bottom side of the varistor module. The varistor 1 is fixed to the terminal 4 via the contact elements 2, 3 which are fixed to the terminal 4. The terminal 4 is surface mounted to the SMD application, e.g. to a printed circuit board.

The plastic base 6 of the terminal 4 comprises a plastic material which can withstand high temperatures, for example a liquid crystal polymer (LCP). In particular, the plastic base 6 can withstand the high temperatures which occur during reflow soldering.

The plastic base 6 comprises two spring arms 9 which are configured to snap into openings 10 of a housing 11 in order to attach the terminal 4 to the housing 11.

Two metal contacts 7, 8 are integrated into the plastic base 6. Each of the metal contacts 7, 8 is connected to one of the contact elements 2, 3. FIG. 4 shows a more detailed view of one of the metal contacts 8. The metal contacts 7, 8 consist of Tin plated copper sheet or Tin plated high conductive metal.

Each metal contact 7, 8 comprises a lower face 14 which faces away from the varistor 1, when the terminal 4 is fixed to the varistor 1. The lower face 14 of the metal contact 7, 8 is intended to be surface mounted to an application.

The metal contact 7, 8 further comprises an upper face 15 which is parallel to the lower face 14 and which faces towards the varistor 1, when the varistor 1 is fixed to the terminal 4. Each metal contact 7, 8 is U-shaped, wherein the lower face 14 and the upper face 15 of the metal contact are connected by the short connecting piece 16 which is perpendicular to the lower face 14 and perpendicular to the upper face 15.

The metal contact 7, 8 comprises a welding area 17 which is formed by a wall that is arranged on the upper face 15 and that is perpendicular to the upper face 15. The welding area 17 protrudes from the upper face 15 towards the varistor 1. Each contact element 2, 3 of the varistor 1 is welded to the welding area 7 of the respective metal contact 7, 8.

During welding, high temperatures occur only locally at the position at which the contact element 2, 3 is welded to the welding area 17. Accordingly, the high temperature occurs locally at the end of the strap-shaped contact element 2, 3 which is opposite to the end of the contact element 2, 3 which is fixed to the varistor 1. As the heat has to travel along the contact element 2, 3 before reaching the connection to the varistor 1, the heat is partly radiated to the environment and only partly applied to the connection of the contact element 2, 3 and the varistor 1. The strap shaped contact elements 2, 3 are constructed long enough such that a sufficient amount of heat is radiated to the environment and the heat applied during welding of the contact elements 2, 3 to the terminal 4 does not damage the connection between the contact element 2, 3 and the varistor 1.

In an alternative embodiment, each contact element 2, 3 of the varistor 1 is soldered to the welding area 7 of the respective metal contact 7, 8 using a high temperature solder which does not melt during reflow soldering in an SMD process. During soldering with the high temperature solder, heat is also applied only locally at the end of the strap-shaped contact element 2, 3 which is opposite to the end of the contact element 2, 3 which is fixed to the varistor 1. The strap shaped contact elements 2, 3 are constructed long enough such that a sufficient amount of heat is radiated to the environment and the heat applied during soldering of the contact elements 2, 3 to the terminal 4 does not damage the connection between the contact element 2, 3 and the varistor 1.

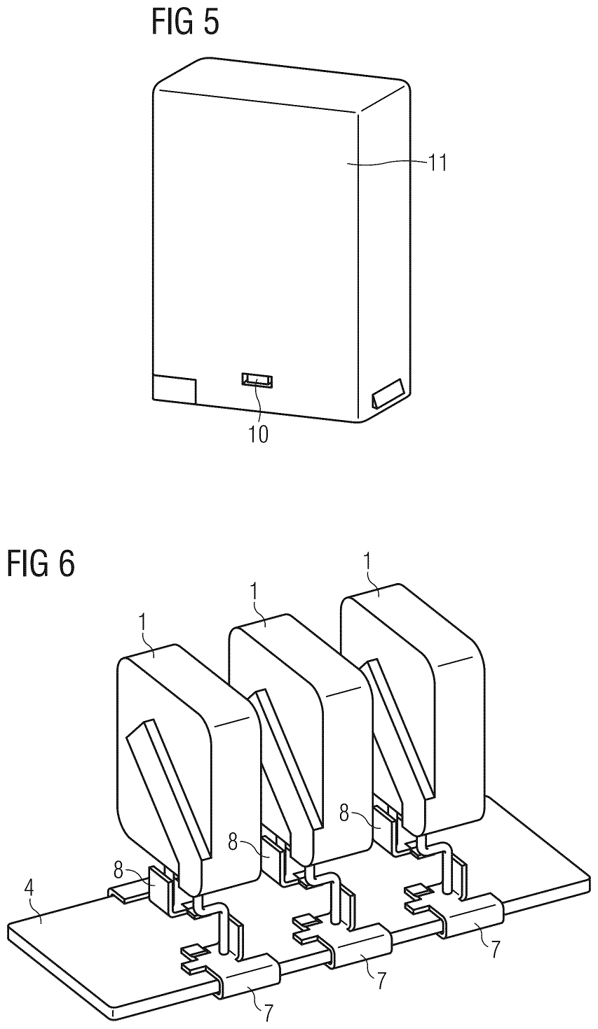

FIG. 5 shows a perspective view of the final product of the varistor module. The varistor module comprises the housing 11 which was not shown in FIGS. 1 and 2.

The housing 11 is attached to the terminal 4. The housing comprises two openings 10, wherein the spring arms 9 of the terminal 4 are snapped into the openings 10.

The housing 11 and the terminal 4 enclose a cavity in which the varistor 1 and the contact elements 2, 3 are arranged. The varistor 1 and the contact elements 2, 3 are protected by the housing 11.

The housing 11 has a cubic shape wherein a bottom is missing. When the housing 11 is attached to the terminal 4, the terminal 4 forms the bottom of the cavity and the housing 11 forms the other walls of the cavity. The lower face 14 of the metal contact 8 is contactable as a mounting partner for surface mounting. In particular, the lower face 14 may be fixed to a printed circuit board during an SMD process, in particular during reflow soldering.

The housing 11 may comprise a plastic material. For example, the housing 11 can comprise the same plastic material as the plastic base 6 of the terminal 4. For example, the housing 11 and the plastic base 6 may both comprise an LCP. Alternatively, the housing 11 may comprise a material other than the plastic base 6.

When the housing 11 is fixed to the terminal 4, an air layer is formed inside the housing 11 between an inner surface of the housing 11 and the varistor 1. Accordingly, neither the varistor 1 nor the contact elements 2, 3 abut any of inner surfaces of the housing 11.

The air layer inside the housing 11 partly absorbs heat which occurs during SMD processes, for example during reflow soldering, such that a lower amount of heat is applied to the connection between the contact elements 2, 3 and the varistor 1. Accordingly, the air layer inside the housing 11 lowers the heat transfer to the connection of the contact elements 2, 3 and the varistor 1 during SMD processes.

FIG. 6 shows a varistor module according to a second embodiment. According to the second embodiment, multiple varistors 1 are arranged on a single terminal 4. In the embodiment shown in FIG. 6, three varistors 1 are arranged on the terminal 4. However, any other number of varistors 1 may also be used.

The terminal 4 comprises one single plastic base 6 and two metal contacts 7, 8 for each of the varistors 1. The metal contacts 7, 8 are formed and arranged in the same manner as described above with respect to the first embodiment. Each metal contact 7, 8 is configured to be surface mounted and each metal contact 7, 8 comprises a welding area 14 which is configured to be welded or soldered using high temperature solder to the respective contact element 2, 3. Additionally, a housing 11 may be provided which is fixed to the terminal 4 such that the terminal 4 and the housing 11 enclose a cavity in which the varistors 1 and the contact elements 2, 3 are arranged.

Compared to a varistor module in which the contact elements are directly used as mounting partners in surface mounting onto an SMD application, the varistor module according to the present invention can better withstand the heat during the SMD process. In particular, the connection between the contact elements 2, 3 and the varistor 1 is better protected from melting.

In both embodiments, multiple measures prevent or lower the heat transfer during the SMD process to the connection between the contact elements 2, 3 and the varistor 1. By providing the terminal 4 which is surface mounted to the SMD application, the contact elements are not used as mounting partners during surface mounting such that heat is not directly applied to the contact elements 2, 3, but to the terminal 4.

Moreover, by providing the air layer between the inner surface of the housing 11 and the varistor 1, additional isolation of the connection of the varistor 1 and the contact elements 2, 3 is provided. Moreover, by providing a coating of the varistor 1 and the contact elements 2, 3, the connection is made more heat resistant.

The terminal 4 can be combined with already existing leaded varistors to form a surface mountable package. The varistor module is a low cost varistor module with high surge capability. The connection of the contact elements 2, 3 to the respective metal contact 7, 8 can withstand the high temperatures of reflow soldering and also the high frequency vibrations which are common in automotive field applications. Overall, the varistor module has a simple structure which is easily integrated in automatic production.

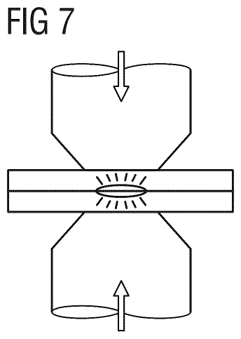

FIG. 7 shows the welding method of the welding process.

### REFERENCE NUMBERS

1 varistor
2 contact element
3 contact element
4 terminal
5 coating
6 plastic base
7 metal contact
8 metal contact
9 spring arm
10 opening
11 housing
14 lower face
15 upper face
16 connecting piece
17 welding area

What is claimed is:

1. A varistor module comprising:
a varistor;
a contact element fixed to the varistor; and
a terminal comprising a metal contact, wherein the contact element is fixed to the metal contact and wherein the metal contact comprises a lower face which faces away from the varistor and which is configured for surface mounting.

2. The varistor module according to claim 1, wherein the contact element comprises lead which is coated with copper or tin.

3. The varistor module according to claim 1, wherein the contact element is fixed to the varistor by soldering or by welding.

4. The varistor module according to claim 1,
wherein the contact element is fixed to the metal contact by welding or by soldering using a high temperature solder.

5. The varistor module according to claim 1, wherein the terminal further comprises a plastic base, wherein the metal contact is integrated in the plastic base.

6. The varistor module according to claim 5, wherein the plastic base comprises a liquid crystal polymer or another plastic material.

7. The varistor module according to claim 1, wherein the metal contact further comprises:
an upper face; and
a welding area,
wherein the upper face is parallel to the lower face and faces towards the varistor,
wherein the welding area is perpendicular to the upper face of the metal contact and protrudes towards the varistor, and
wherein the contact element is welded to the welding area of the metal contact.

8. The varistor module according to claim 1, wherein the varistor and the contact element are covered by a coating.

9. The varistor module according to claim 1, further comprising:
a housing,
wherein the terminal and the housing enclose a cavity, and
wherein the varistor and the contact element are arranged in the cavity.

10. The varistor module according to claim 9, wherein air is arranged between an inner surface of the housing and the varistor.

11. The varistor module according to claim 1, further comprising:
at least a second varistor wherein a second contact element is fixed to the second varistor, and
wherein the terminal further comprises a second metal contact,
wherein the second metal contact is fixed to the second contact element and wherein the second metal contact comprises a lower face which faces away from the second varistor and which is configured for surface mounting.

12. The varistor module according to claim 1,
wherein the varistor comprises a first outer electrode at its upper surface and a second outer electrode at its lower surface,
wherein the contact element is fixed to the first electrode of the varistor by soldering or welding,
wherein the varistor module comprises a second contact element which is fixed to the second electrode of the varistor by soldering or welding, and
wherein the terminal further comprises a second metal contact, wherein the second contact element is fixed to the second metal contact and wherein the second metal contact comprises a lower face which faces away from the varistor and which is configured for surface mounting.

13. A method of manufacturing a varistor module comprising:
providing a varistor with a contact element fixed to the varistor;
providing a terminal comprising a metal contact, the metal contact comprising a lower face configured for surface mounting; and
fixing the contact element to the metal contact such that the lower face of the metal contact faces away from the varistor.

14. The method according to claim 13, further comprising:
placing a housing over the varistor and over the contact element, such that the terminal forms a bottom side of the housing.

15. The method according to claim 13, wherein the contact element is fixed to the varistor by soldering or by welding.

16. The method according to claim 13, further comprising:
providing a second varistor with a second contact element fixed to the second varistor,
wherein the terminal comprises a second metal contact, which comprises a lower face configured for surface mounting; and
fixing the second contact element to the second metal contact such that the lower face of the second metal contact faces away from the second varistor.

17. The method according to claim 13,
wherein the varistor comprises a first outer electrode at its upper surface and a second outer electrode at its lower surface,
wherein the contact element is fixed to the first electrode of the varistor by soldering or welding,
wherein the varistor module comprises a second contact element which is fixed to the second electrode of the varistor by soldering or welding, and
wherein the terminal comprises a second metal contact, wherein the second contact element is fixed to the second metal contact and wherein the second metal contact comprises a lower face which faces away from the varistor and which is configured for surface mounting.
